(19) United States
(12) Patent Application Publication
(10) Pub. No.: US 2004/0040145 A1
(43) Pub. Date: Mar. 4, 2004

(54) Method for making a decorative metal sheet

(76) Inventors: James W. Halliday JR., Gibsonia, PA (US); Frederic J. Deuschle, Wexford, PA (US)

Correspondence Address: PAUL A. BECK & ASSOCIATES, SUITE 100, 1575 McFARLAND ROAD, PITTSBURGH, PA, 15216-1808, US

(21) Appl. No.: 10/325,221

(22) Filed: Dec. 20, 2002

Related U.S. Application Data
(60) Provisional application No. 60/406,911, filed on Aug. 29, 2002.

(51) Int. Cl. B23P 17/00; H01F 7/06

(52) U.S. Cl. 29/605; 29/527.1; 29/558

(57) ABSTRACT

A method for making a decorative metal sheet through means of a coiled strip blasting line. Coiled metal strip is unwound, passed through a blast room, and rewound at the exit end of the line. In the blast room section, a mixture of recycled blasting media is combined with fresh material to create a controlled, steady-state blast media mixture that is projected, by a bank of air pressure nozzles onto the surface of the strip to create the desired decorative effect.

### CROSS-REFERENCE TO RELATED APPLICATION:

This application claims benefit of Provisional patent application Serial No. 60/406,911 and entitled “Method for Making a Metal Sheet Through Means of a Coiled Strip Blasting Line”, the teachings of which are incorporated herein by reference.

### BACKGROUND OF THE INVENTION

1. Field of the Invention

This invention generally relates to a method for making a decorative metal sheet and more specifically relates to a method for using a coiled strip blasting line to create a surface decorative pattern on a metal sheet.

2. Description of the Related Art

The art of treating metal with impingement of media has been practiced in stainless steel mills for many years as a means to pre-treat scale in continuous anneal and pickle lines. While this art is similar in that it involves coiled metal under tension, it is quite different, in that the media delivery system relies on rotary wheel equipment that slings media (usually steel shot) on the material surface to break down the scale to facilitate acid cleaning of the strip. The process is not designed for cosmetic purposes and the rotary equipment limits media choices to spherical shapes. The following U.S. Patents relate to this technology:

| | | |
|---|---|---|
| 5,279,141 | Jan. 18, 1994 | Kenmochi et at. |
| 6,361,613 | Mar. 26, 2002 | Lee |
| 4,978,853 | Dec. 18, 1990 | Wakui et at. |

U.S. Pat. No. 3,991,462 to Engel dated Oct. 28, 1975 discloses a mechanical apparatus for finishing coiled strip through the use of rotating brushes.

U.S. Pat. No. 6,138,490 to Shannon dated Oct. 31, 2000 and U.S. Pat. No. 6,153,316 also to Shannon dated Nov. 28, 2000 relate to creating decorative textures on coiled metal sheet stock on cold reducing mills.

U.S. Pat. No. 4,449,331 to MacMillan dated May 22, 1984 involves a blast media separator system that removes spent particles and contaminants from the mixture of reusable media.

Decorative media blasted metal sheets are currently produced one sheet at a time. This is often done by hand in fabrication shops.

There is a known process line in Japan wherein individual metal sheets are mounted more or less on edge on a conveyor. The conveyor allows the material (usually stainless steel) to travel through a blast room, where the surface is blasted with various media (often glass beads) to achieve the desired cosmetic result.

A problem associated with this process is that when the surface is blasted it increases the surface area of the metal on the blasted side thus causing the metal to bow out on the untreated side. In order to alleviate the shape distortion both sides of the metal are blasted in order to create the equivalent increase of surface area on both sides. This solution is inefficient and does not always produce a flat sheet. Additional flattening steps, such as roller leveling or stretch leveling are often required.

### SUMMARY OF THE INVENTION

This invention provides a method for making a decorative metal sheet surface by providing a coil of sheet metal, paying off the sheet metal from the coil, and blasting a surface of the sheet metal with a medium carried by air pressure greater than atmospheric pressure. Using a plurality of nozzles for delivering the medium carried under air pressure can do the blasting step. The nozzles transverse a width of the sheet metal in a reciprocating manner. The spent medium can be recovered and fines can be removed from the spent medium leaving rechargeable medium. The rechargeable medium can be blended with new medium to provide a steady state medium.

Making decorative metal sheets on a coiled strip blasting line provides substantial improvement to existing methods. First, higher quality can be realized. The coiled strip blasting line relies on a compressed air delivery system with an oscillating distribution head, capable of evenly spreading media of various shapes on the surface of the strip to create a visually uniform surface. Second, lower costs are anticipated since only one side needs to be blasted and shape correction of the metal can occur in coil form.

### BRIEF DESCRIPTION OF THE DRAWINGS

FIG. 1 A diagrammatic rendition of the flow of one embodiment of the method.

FIG. 2 A diagrammatic rendition of the blast room.

### DETAILED DESCRIPTION OF THE INVENTION

Definitions

“Decorative metal sheet surface” means a texture or surface aspect that provides a certain desirable appearance.

“Sheet Metal” means a flat rolled metallic material, including but not limited to steel, titanium, zinc, aluminum or copper in the form of coils or cut lengths of any thickness.

“A coil of sheet metal” means sheet metal that is wound onto itself in a roll.

“Paying off” means unwinding the coiled sheet metal, which rotates about a mandrel.

“Blasting a surface” means impinging the surface of a material with various projected media.

“Medium” means material including but not limited to glass beads, shot and garnet that is intended to be projected onto a material surface.

“Carried by air by air pressure” means projected at a certain velocity by means of air pressure.

“Greater than atmospheric pressure” means a pressure sufficient to project media through a nozzle.

“Plurality of nozzles” means more than one nozzle, or distribution opening.

“Delivering the medium” means projecting material particles through the system.

“Nozzles traverse a width of the sheet metal in a reciprocating manner” means a bank of nozzles that index from side-to-side as the sheet metal passes through their range.

“Spent medium” means material particles that have previously impacted the sheet metal surface.

“Fines” means spent medium particles that are no longer of sufficient size to perform their intended task.

“Leaving rechargeable medium” means after fines are filtered out the residual medium or material particles that are of sufficient size to perform their intended task.

“Blending the rechargeable medium” means mixing material particles of sufficient size to perform their intended task with presumably fresh medium.

“Steady state medium” means that mixture of new and recycled particles that is continually relieved of spent medium, or fines, as fresh medium is added, so as to maintain itself as a uniform combination of particles of varying sizes over time.

“Recoiling” means winding the paid off coil about a mandrel so as to create a continuous roll of metal.

Description

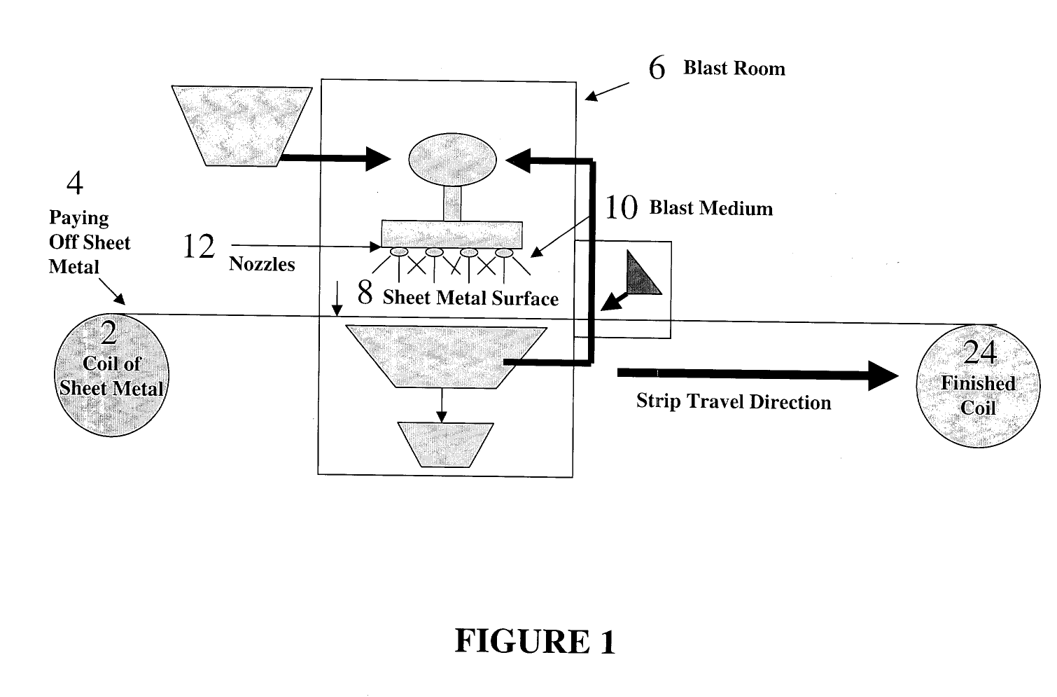

FIG. 1 shows a schematic representation of the process. A coil of sheet metal 2 is provided. The process then provides for paying off the sheet metal 4 from the coil 2. The paid off sheet metal 4 is passed through a blast room 6 where the surface 8 of the paid off sheet metal 4 is blasted with a medium 10 carried by air pressure grater than atmospheric. A plurality of nozzles 12 are used for delivering the medium 10 carried by air pressure. The nozzles 12 transverse the width of the sheet metal in a reciprocating manner. After the paid off sheet metal 4 has been blasted it is it is rewound into a finished coil 24.

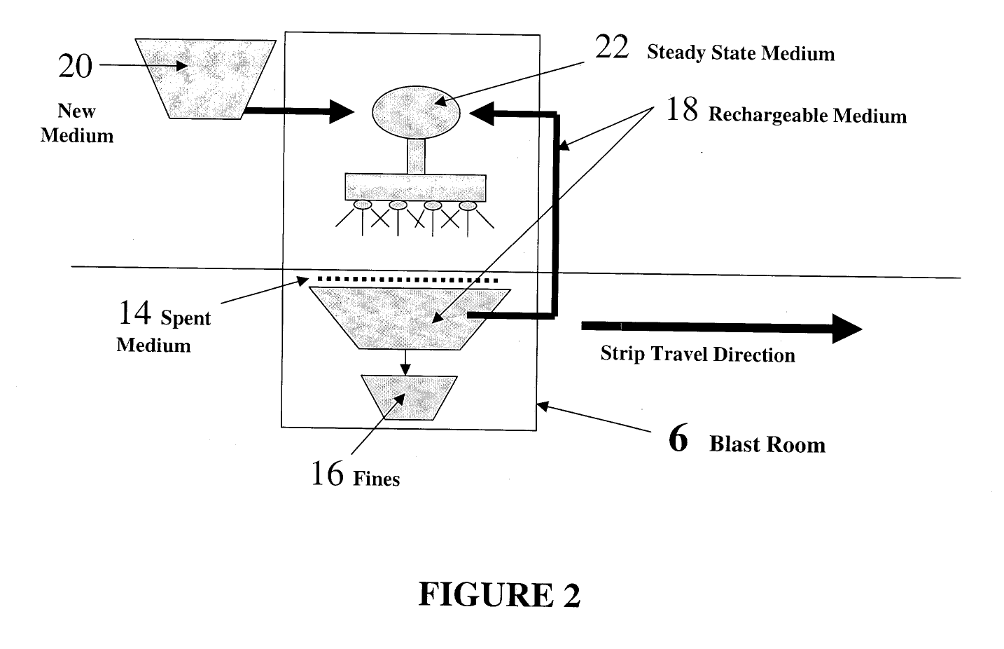

FIG. 2 shows a schematic representation of the blast room. In the blast room 6 spent medium 14 is recovered. Fines 16 are sifted from the spent medium 14 leaving rechargeable medium 18. The rechargeable medium is then mixed with new medium 20 resulting is a steady state medium 22.

In a preferred embodiment the coil of sheet metal 2 can be loaded onto a mandrel, allowing the metal to be uncoiled (paying off the sheet metal 4) and fed into the blast room 6. The coil of sheet metal 2 can be welded to a leader strip, or to the preceding coil allowing the re-coiler on the other end of the line to maintain a connection. The speed of the simultaneous unwinding and rewinding of the coiled metal strip shall be controlled. The line will be capable of processing a variety of metals, including stainless steel, titanium, zinc, copper and aluminum. A substantial number of textures exhibiting varying degrees of reflectivity can be achieved.

The blast room 6 contains the necessary equipment to bombard the surface of the strip with medium 10 as the strip passes through. The blast room 6 is also a containment vessel that will recapture spent medium 14. Fines 16 (pulverized particles no longer large enough to create the desired effect) are filtered out of the spent medium 14 to create a rechargeable medium 18. Fresh medium 20 is continuously added to the rechargeable medium 18 to create a steady state medium 22. The resultant steady state medium 22 mix is a uniform mixture of particles, which is conducive to a “steady state” of operation.

A distribution head has a plurality of nozzles 12 is used to blast the sheet metal. The plurality of nozzles 12 oscillate as a set, promoting uniformity and eliminating unwanted transition lines from the edges of spray zones.

An air knife is used to clean the surface of the sheet metal by forcing residual particles back into the blast room 6 as the sheet exits. The finished sheet is recoiled. It is now ready for shape correction on a coil stretch line and cutting to length for customer delivery.

The coiled strip blasting line involves processing material in coil form. Since the coil terminal equipment will maintain tension on the strip being processed, only one side of the material (the exposed decorative side) needs to be blasted. Once the coil is processed, however, it will most certainly contain a degree of shape distortion that will need to be corrected. This can be done as a coil product more economically than roller leveling or stretching individual sheets.

Various changes could be made in the above construction and method without departing from the scope of the invention as defined in the claims below. It is intended that all matter contained in the above description as shown in the accompanying drawings shall be interpreted as illustrative and not as a limitation.

We claim:

1. Method for making a decorative metal sheet surface comprising:
a. providing a coil of sheet metal;
b. paying off the sheet metal from the coil; and
c. blasting a surface of the sheet metal with a medium carried by air pressure greater than atmospheric pressure.

2. Method for making a decorative metal sheet surface as recited in claim 1 wherein blasting the surface of the sheet metal is done by a plurality of nozzles for delivering the medium carried under air pressure and in which the nozzles traverse a width of the sheet metal in a reciprocating manner.

3. Method for making a decorative metal sheet surface as recited in claim 1:
a. recovering the spent medium;
b. removing fines from the spent medium leaving rechargeable medium; and
c. blending the rechargeable medium with new medium resulting in a steady state medium.

4. Method for making a decorative metal sheet surface as recited in claim 1 wherein the medium is a variety of both spherical and angular shapes.

5. Method for making decorative metal sheet surface as recited in claim 1 including recoiling the blasted sheet metal.
